(19) United States
(12) Patent Application Publication
(10) Pub. No.: US 2009/0145953 A1
(43) Pub. Date: Jun. 11, 2009

(54) CONTAINERS FOR HOLDING AND DISPENSING ITEMS AND METHODS FOR ASSEMBLING THE SAME

(76) Inventors: JULES ANDREW HEINEMANN III, Chicago, IL (US); Daniel Scott Carey, Midlothian, IL (US); Paul Steven Scriba, Western Springs, IL (US)

Correspondence Address: COOK ALEX LTD, SUITE 2850, 200 WEST ADAMS STREET, CHICAGO, IL, 60606, US

(21) Appl. No.: 11/950,892

(22) Filed: Dec. 5, 2007

(51) Int. Cl. B65D 25/00; B65D 5/72; B65D 3/04; B31B 7/00

(52) U.S. Cl. 229/116.1; 229/122.1; 229/4.5; 493/94

(57) ABSTRACT

Containers for holding and dispensing a plurality of items and methods of assembling the same are disclosed. The containers include a sidewall having an aperture therein, a bottom, and an interior flow control guide to force the items through a rearward restricted passage as the items move within the container downward toward the bottom and forward toward the aperture in the sidewall. A plurality of items are simultaneously accessible through the aperture.

### FIELD OF THE DISCLOSURE

This disclosure relates generally to containers for holding items and, more particularly, to containers used to display and dispense items and methods of assembling the same.

### BACKGROUND

It is common to display and dispense goods, generally referred to herein as items, within a retail environment on shelves, countertops or racks. It also is common to display and dispense items at gatherings, such as gift items for attendees at conventions, that may be located on tables or shelves. Often the goods are held within a larger container, such as when multiple smaller packaged items are shipped within a box and the box then has a lid or front panel removed before setting the box on a store shelf or table to display and dispense the smaller packaged items. Boxes and containers have been available for displaying and dispensing items in various forms, but tend to be complicated in form and assembly or simple boxes that lack specialized or stylized features. The typical boxes essentially rely on the packaging of the smaller packaged items for attractiveness in merchandising. Some boxes and containers are configured for use to dispense one item at a time, while others for instance are simply cut open to make readily available all of the items.

The present disclosure addresses the issue of display or retail merchandising space being inherently limited, while providing an enhanced, low cost container for displaying and dispensing a plurality of goods in a controlled manner, as well as offering an opportunity for the display dispenser to have a whimsical or stylized presentation. The disclosure also addresses the need of retailers for flexibility in arranging point of purchase displays to best utilize merchandising space, by providing containers that may be shipped flat and quickly assembled, while being conveniently refillable. This, in turn, allows manufacturers of the goods to be dispensed to either ship the goods in pre-assembled containers, or to ship the goods in bulk to then be added to assembled containers at the intended point of dispensing.

### BRIEF DESCRIPTION OF THE DRAWINGS

FIG. 1 is a perspective view of a first example container for use in displaying and dispensing items.

FIG. 2 is an exploded perspective view of the first example container shown in FIG. 1, unassembled.

FIG. 3 is a side view of the first example container shown in FIG. 1.

FIG. 4 is a cross-sectional side view of the first example container shown in FIG. 1.

FIG. 5 is a front view of the first example container shown in FIG. 1.

FIG. 6 is a top view of the first example container shown in FIG. 1.

FIG. 7 is a perspective view of the first example container shown in FIG. 1 with a first example lid.

FIG. 8 is a perspective view of the first example container shown in FIG. 1 with a second example lid.

FIG. 9 is a perspective view of a second example container for use in displaying and dispensing items.

FIG. 10 is an exploded perspective view of the second example container shown in FIG. 9, unassembled.

FIG. 11 is a cross-sectional side view of the second example container shown in FIG. 9.

FIG. 12 is a perspective view of a third example container for use in displaying and dispensing items.

FIG. 13 is a perspective view of the third example container shown in FIG. 9, unassembled.

### DETAILED DESCRIPTION

Although the following discloses example containers for use in displaying and dispensing items, and which may be placed on flat surfaces, such as a desk, countertop or shelf, it will be understood by one of ordinary skill in the art that such containers also may be suspended from such structures or from generally vertical structures, such as walls or shelving stanchions, and that the teachings of this disclosure are in no way limited to such specific examples. On the contrary, it is contemplated that the teachings of this disclosure may be implemented in alternative configurations and environments. For example, although the example containers described herein are described in conjunction with configurations for displaying and dispensing items from a shelf and in a retail environment and for use with such items as candy, lip gloss, trial size tooth paste, or oral related products, those having ordinary skill in the art will readily recognize that the example containers may be used to display and dispense other types of goods and may be configured to correspond appropriately to the goods to be displayed, whether requiring additional attachments or supports, or other stylized features.

Similarly, the disclosed examples may be used in any type of format to display and dispense goods. Thus, the methods, apparatus, and/or articles of manufacture disclosed herein may be advantageously adapted to enhance or improve the organization, display or dispensing of any type of goods. Accordingly, while the following describes example containers and methods of use thereof, persons of ordinary skill in the art will readily appreciate that the disclosed examples are not the only way to implement such containers and/or methods.

In general, the example containers and/or methods described herein facilitate convenient, cost effective point of purchase display and dispensing of goods. In the examples shown, the containers may be placed on generally horizontal surfaces, such as is provided by a desk, countertop, shelf or the like. It will be appreciated that the containers may otherwise be adapted to be hung from such surfaces or from substantially vertical surfaces having attachment means.

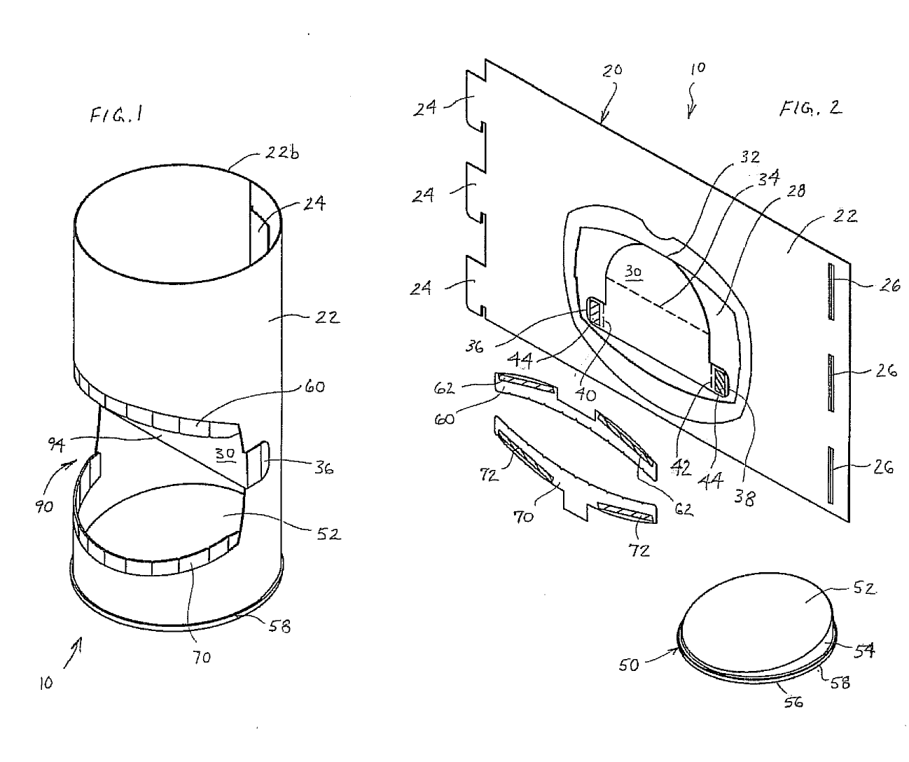

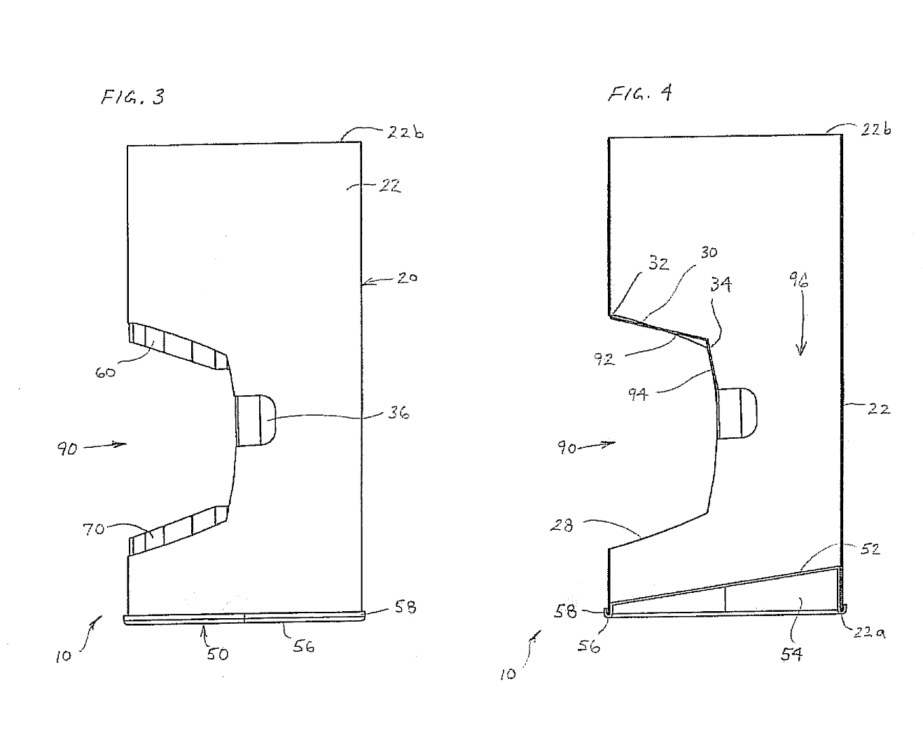

A first example container 10 is illustrated in FIGS. 1-6. The illustrated example container 10 includes a panel or blank 20, a bottom 50, an upper teeth portion 60 and a lower teeth portion 70. The blank 20 may be die-cut from sheet material, such as plastic, cardboard or any suitable sheet product. In this example, the blank 20 includes features to assist in the quick assembly of the container 10 and in the controlled flow of items that will be placed within the container. The blank 20 may also include integrated additional features that help promote a whimsical theme. For instance, the example blank 20 includes a sidewall 22 with at least one tab 24 at one end and a corresponding tab engaging slots 26 at the opposite end. The blank 20 also includes an aperture 28 therethrough that is designed to leave an inner wall 30 that is connected to the sidewall 22 at an upper fold line 32. A second fold line 34 is located between the top and bottom of the inner wall 30. The inner wall 30 also includes side tabs 36, 38 that extend beyond respective third and fourth fold lines 40, 42. In this example, a rear surface of each tab 36, 38 includes a fastening means 44, which may be, for example a portion of double-sided adhesive tape. Other suitable chemical or mechanical fastening means may be used as well.

With the example panel or blank 20 described above and the bottom 50, a container may be formed. In particular, the blank 20 is rolled or bent into a cylindrical shape, and the tabs 24 are inserted through the slots 26 from an outer side of the sidewall 22. Once the tabs 24 are located inside of the formed sidewall 22, the end of the blank 20 having the tabs 24 is shifted downward relative to the end of the blank 20 having the slots 26. This movement locks the tabs 24 within the slots 26 to form a tubular sidewall 22 in the shape of a cylinder having a bottom edge 22a in a common plane with an upper end 22b. In this example, the tubular sidewall 22 is rounded, in alternative examples the tubular sidewall may be rectangular, polygonal, or otherwise continuously shaped. While the tab and slot formation provides a particularly cost effective connection, it will be appreciated by one of ordinary skill in the art that other end formations of the sidewall and fastening means may be used to form a suitable tubular sidewall.

The inner wall 30 is bent rearward and upward, toward the center of the cylinder interior, about the first fold line 32. The inner wall 30 also is bent about the second fold line 34 to project downward in a generally more vertical manner and to bring the side tabs 36, 38 into position along the sides of the aperture 28. The tabs 36, 38 of the inner wall 30 are bent rearward at respective third and fourth fold lines 40, 42 to be positioned adjacent the outer surface of the sidewall 22. The fastening means 44 on each of the tabs 36, 38 then is employed to connect the inner wall 30 to the sidewall 22. The connection of the tabs 36, 38 to the outer surface of the sidewall 22 places the inner wall 30 in tension, and the connections at fastening means 44 in shear, thereby also lending support against the outward bowing of the sidewall 22 at the sides of the aperture 28. It will be appreciated that other methods and means of connection may be employed, and depending on the materials and methods of forming of the sidewall 22, such additional support may or may not be necessary.

The upper teeth portion 60 has a pair of fastening means 62 on a front surface thereof. The upper teeth portion 60 may thereby be positioned adjacent the inner surface of the sidewall 22, at the upper edge of the aperture 28, and connected to the inner surface of the sidewall 22 by the fastening means 62. The lower teeth portion 70 has a pair of fastening means 72 on a front surface thereof. The lower teeth portion 70 may thereby be positioned adjacent the inner surface of the sidewall 22, at the lower edge of the aperture 28, and connected to the sidewall 22 the fastening means 72. The fastening means 62, 72 may be any suitable chemical or mechanical fasteners.

The bottom 50 may be formed as a cap having a central portion 52 connecting a cylindrical sidewall 54, and a rim 56 extending in a plane outward from the sidewall 54. The bottom 50 may be formed from any suitable material, such as plastic, cardboard or other such products or the like. The central portion 52 is angled relative to the plane of the rim 56. The bottom 50 is sized to fit within the lower end of the cylinder formed by the sidewall 22, and may be connected thereto in a relatively durable manner by, for example, adhesive (not shown). It will be appreciated by one of ordinary skill in the art that the bottom 50 also may be sized to form a plug fit in the lower end of the cylinder formed by the sidewall 22, or for a more durable connection while permitting less stringent tolerances, adhesive or other fastening means, such as staples or the like, may be used. The rim 56 extends outward from the sidewall 54 to provide a stop as the bottom 50 is inserted into the lower end of the cylinder formed by the sidewall 22. In the example shown, the rim 56 also includes an upward extending portion 58 spaced from the sidewall 54 sufficiently to capture therebetween the sidewall 22. Capturing the sidewall 22 in this manner provides further support against potential distortion of the sidewall 22, and when using adhesive for fastening, improves the ability to hide any excess adhesive.

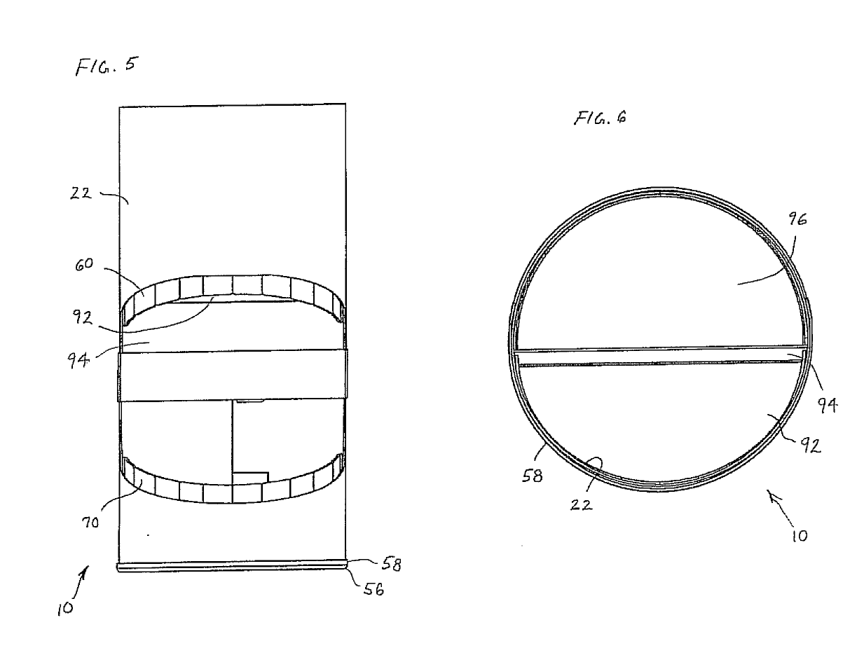

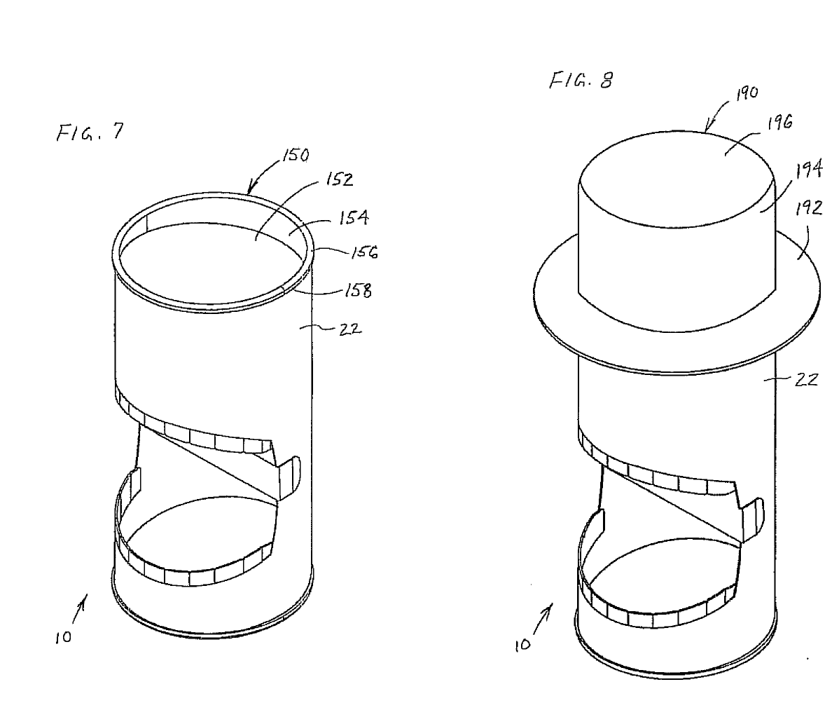

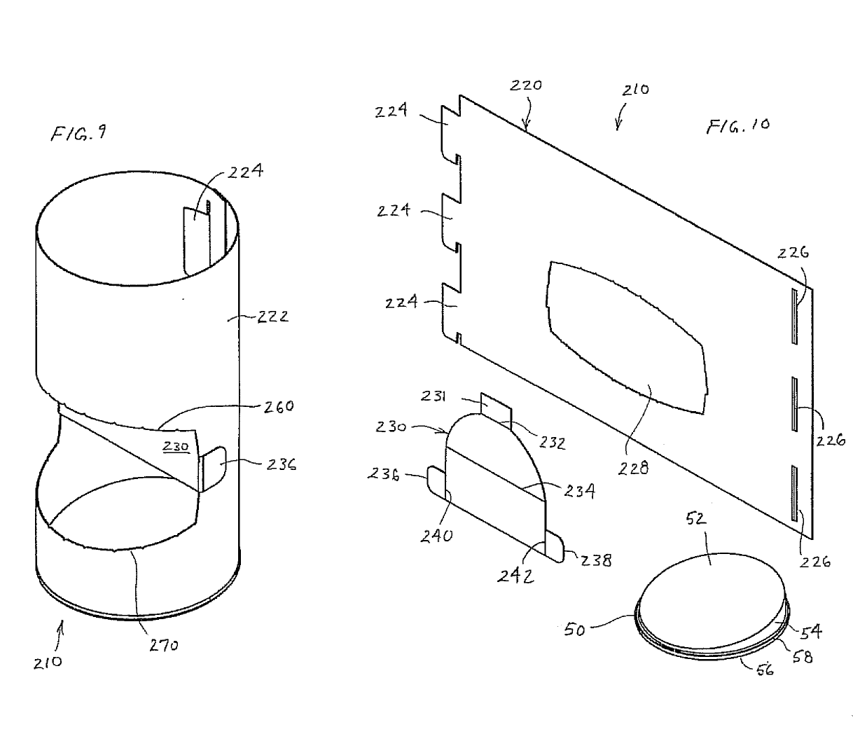

With the example container of FIGS. 1-6 assembled, as illustrated in FIGS. 4-6, the inner wall 30 forms a first interior flow control guide to partially constrict the downward flow of items added through the upper end 22b of the container 10. The aperture 28 forms a mouth 90 and the inner wall 30 essentially forms a palate 92 between the first and second fold lines, and what appears through the aperture 28 to be a back of a throat 94 between the second fold line and the bottom of the inner wall 30. The inner wall 30 also forms a passage 96 at the rear of the container 10. The angled central portion 52 of the bottom 50 is inclined toward the rear of the container and forms a second interior flow control guide which further assists in constricting the flow of items downward through the passage 96 at the rear of the container 10, while also tending to advance forward those items that have passed through the passage 96 and have reached the lower portion of the container 10.

Thus, with the example advantageous structure, items may be loaded at the upper end 22b of the container 10 and the items will flow in a controlled manner downward through the container 10 and the passage 96 until the items reach the bottom 50 and are accessible through the mouth 90. As items are withdrawn from the mouth 90, space is made available for further items to advance through the passage 96 toward the bottom 50. Accordingly, the flow within the container 10 is self-regulating. In addition, one or more items may be accessible through the aperture simultaneously.

The components of the container 10 may include particular coloration or printing to enhance the presentation or whimsical nature of the display. For instance, the teeth portions may be generally white with dark lines separating respective teeth, lips may be printed around the aperture 28, the inner wall and areas of the mouth 90 may be of an appropriate color, while the outer surface of the container 10 beyond the mouth or lips may be of an appropriate flesh tone or other suitable color. Also, the tabs 36, 38 may have one or more different color areas to correspond with their overlapping location adjacent any lip or flesh toned areas to better conceal the tabs. Layering of various components also may be used to enhance the visual appeal, such as the placement of the teeth portions 60, 70 against the inner surface of the sidewall 22, thereby making the teeth appear to be located inward of the lips. As will be appreciated by one of ordinary skill in the art, the present example presents an opportunity to devise many attractive and even whimsical designs. Such designs may tend to welcome or naturally coax an observer to place a hand in the mouth of the container, thereby facilitating enhanced distribution of the items held within the container 10.

As also will be appreciated by one of ordinary skill in the art, with the present example, display and dispensing containers 10 may be shipped as a pre-assembled containers, with items already inside and with an outer removable wrapping for immediate set up and use. Also, the containers 10 may be partially pre-assembly, such as with the teeth portions 60, 70 connected to the blanks 20 and with such sub-assemblies shipped flat and in bulk along with a corresponding group of bottoms 50. The containers 10 also could be shipped completely disassembled, requiring slightly more assembly upon receipt by the party utilizing the containers 10. Regardless of the format chosen to ship the containers 10, items to be displayed and dispensed in the containers 10 may be shipped in bags or boxes for ready, convenient stocking and refilling of the containers 10 at their upper end 22b.

Turning to FIG. 7, the example container 10 of FIGS. 1-6 is shown in with a first example lid 150. In this example, the lid 150 is provided in the same shape and configuration as a bottom 50, but as opposed to being fastened to the sidewall 22 by adhesive or other means, the lid 150 may form a relatively loose plug fit within the upper end 22b of the container 10 to permit the lid 150 to be removed for filling and refilling of the container 10. Thus, the lid 150 is shown with a central portion 152 connecting a cylindrical sidewall 154, and a rim 156 extending in a plane outward from the sidewall 154. The lid 150 may be formed from similar materials to those mentioned above with respect to bottom 50. The rim 156 extends outward from the sidewall 154 to provide a stop as the lid 150 is inserted into the upper end 22b of the cylinder formed by the sidewall 22. In the example lid 150, the rim 156 also includes a downward extending portion 158 spaced from the sidewall 154 sufficiently to capture therebetween the sidewall 22. As with bottom 50, capturing the sidewall 22 in this manner provides further support against potential distortion of the sidewall 22.

In FIG. 8, another example lid 190 is shown in the form of a hat. The lid 190 includes a brim 192, an upward extending portion 194 terminating in a closed top 196. The brim 192 provides an easy grasping area for installation and removal of the lid 190 from the container 10, while the inner diameter of the upward extending portion 194 may be sized to accept the sidewall 22 to close the container at the upper end 22b. It will be appreciated by one of ordinary skill in the art that other lids may be formed to merely close the container 10 or to additionally enhance the presentation of the container, as with the lid 190 in the form of a hat shown in FIG. 8.

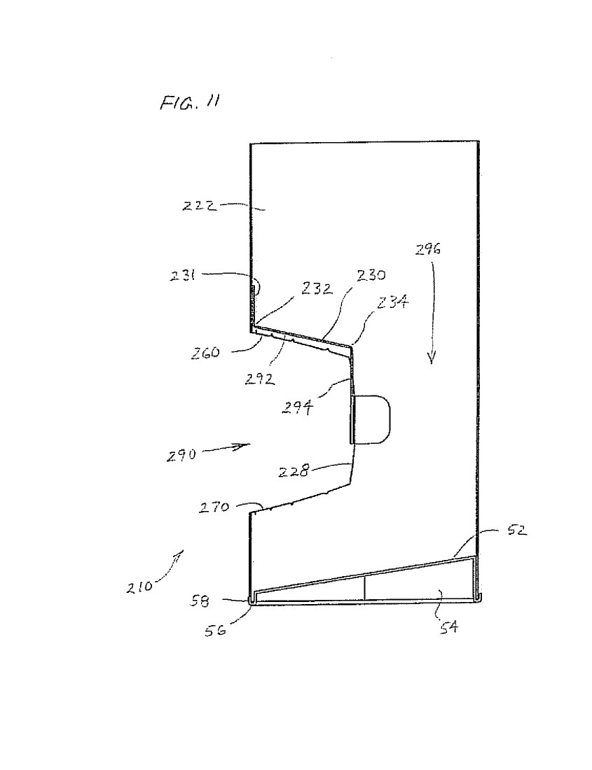

Illustrated in FIGS. 9-11 is another example container 210. The example container 210 includes a panel or blank 220, a bottom 250, an inner wall 230. The blank 220 may be die cut from sheet material, as described above with respect to the first example container 10. The blank 220 includes similar features to assist in the quick assembly of the container 210, while using a separate inner wall 230 for the controlled flow of items that will be placed within the container 210. For instance, the blank 220 includes a sidewall 222, with tabs 224 at one end and tab engaging slots 226 at the opposite end. The blank 220 also includes an aperture 228 therethrough which is designed to show teeth separations along an upper edge 260 and a lower edge 270.

The inner wall 230 may be configured similarly to the above-described inner wall 30, but formed in a separated manner from the common sheet from which the blank 220 is formed. However, to permit connection of the inner wall 230 to the inner surface of the sidewall 222, the inner wall 230 includes an upper tab 231 above a first fold line 232. The inner wall 230 includes a second fold line 234 located between the first fold line 232 and the bottom of the inner wall 230. The inner wall 230 also includes side tabs 236, 238 that extend beyond respective third and fourth fold lines 240, 242. In this example, each tab 236, 238 may be connected to the exterior surface of the side wall 222 by use of adhesive (not shown). However, it will be appreciated that other fastening means may be used.

With the example blank 220 described above and a similar bottom 50, a container 210 may be formed in a similar manner to the container 10. Thus, the blank 220 is rolled or bent into a cylindrical shape, and the tabs 224 are inserted through the slots 226 from an outer side of the sidewall 222. Once the tabs 224 are located inside of the formed sidewall 222, the end of the blank 220 having the tabs 224 is shifted downward relative to the end of the blank 220 having the slots 226 to lock the tabs 224 within the slots 226 to form the sidewall 222 into a cylinder. The inner wall 230 is connected to the sidewall 222 at the tab 231, such as by adhesive or other suitable fastening means. The inner wall 230 is bent rearward and upward, toward the center of the cylinder interior, about the first fold line 232. The inner wall 230 also is bent about the second fold line 234 to project downward in a generally more vertical manner and to bring the side tabs 236, 238 into position along the sides of the aperture 228. The tabs 236, 238 of the inner wall 230 are bent rearward at respective third and fourth fold lines 240, 242 to be positioned adjacent the outer surface of the sidewall 222 and are fastened thereto. It will be appreciated by one of ordinary skill in the art that other methods and means of connection between the inner wall 230 and the sidewall 222 may be employed, whether at a location on the outer or inner surface of the sidewall 222.

In this example, the upper teeth are integrally formed with the sidewall 222 via minor separations along the upper edge 260 of the aperture 228. The separation may be carried further via a line or other illustration to indicate separate teeth. The lower teeth are similarly integrally formed with the sidewall 222 via minor separations along the lower edge 270 of the aperture 228. Also, the second example container 210 may use a bottom 50 identical to that of the above described first example container 10, and may be selectively shipped and assembled in various formats, as desired.

As illustrated in FIG. 11, and similar to the first example container 10, the inner wall 230 of the second example container 210 forms a first interior flow control guide to partially constrict the downward flow of items added through the upper end of the container 210. The aperture 228 forms a mouth 290 and the inner wall 230 essentially forms a palate 292 between the first and second fold lines, and what appears through the aperture 228 to be a back of a throat 294 between the second fold line and the bottom of the inner wall 230. The inner wall 230 also forms a passage 296 at the rear of the container 210. The angled central portion 252 of the bottom 250 is inclined toward the rear of the container and forms a second interior flow control guide which further assists in constricting the flow of items downward through the passage 296 at the rear of the container 210, while also tending to advance forward those items that have passed through the passage 296 and have reached the lower portion of the container 210. Thus, the flow of items in the container 210 is similarly self-regulating.

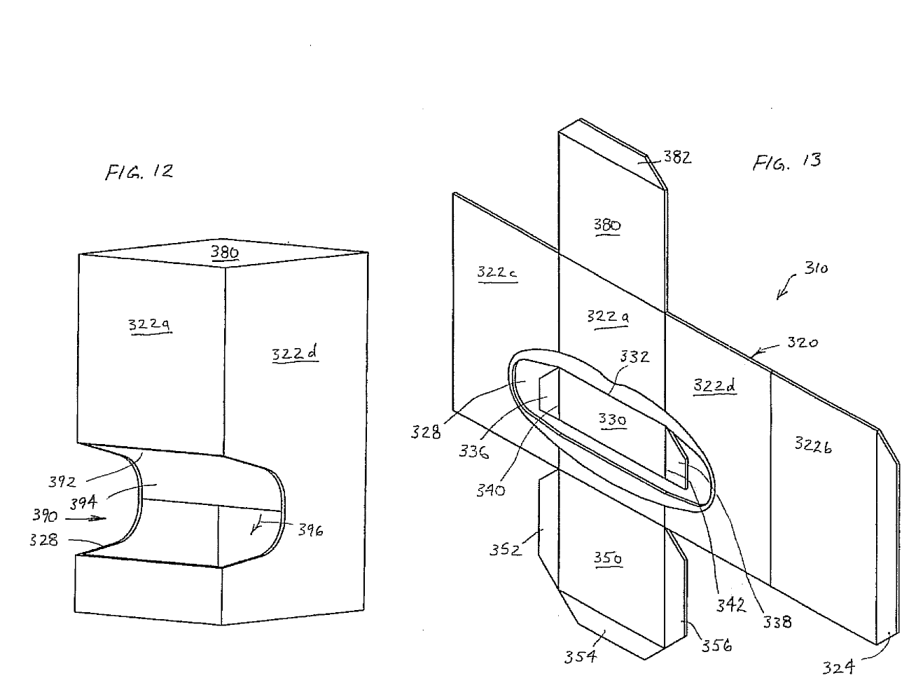

Turning to FIGS. 12 and 13, another example container 310 is illustrated. In this example, the container 310 is formed from one panel or blank 320. The blank 320 has integrally connected thereto a front sidewall 322a, rear sidewall 322b with a connecting tab 324, right sidewall 322c, and left sidewall 322d. The blank 320 also includes an aperture 328 that is configured to leave an inner wall 330 connected to the front wall 322a along a fold line 332, and having side tabs 336, 338 extending outward from further respective fold lines 340, 342. The blank 320 also includes a bottom wall 350 with connecting tabs 352, 354 and 356, as well as a top wall 380 with a tab 382.

The assembled container 310 is formed by folding the sidewalls into a rectangular tube shape and connecting the outer surface of tab 324 to the inner surface of right sidewall 322c, such as by adhesive, double-sided tape or other suitable fasteners. The inner wall 330 is bent into a curved shape to form a palate 392 and rear throat 394, to create a passage 396 in the rear of the container 310, and is connected, such as by adhesive or other suitable fastening means, to the right sidewall 322c and left sidewall 322d at tabs 336, 338, respectively. With the inner wall 330 bent upward and rearward, the aperture 328 forms a mouth 390 for easy access to items within the lower portion of the container 310.

The outer surfaces of tabs 352, 354 and 356 are connected in a similar manner to the inner surfaces of right sidewall 322c, rear sidewall 322b, and left sidewall 322d, respectively, to close the bottom wall 350 of the container 310. The top wall 380 may be used as a lid by having the tab 382 folded to permit insertion into the upper end of the container 310.

It will be appreciated by one of skill in the art that the example container 310 is shown in a simplified format, but as with the prior examples, the container 310 also may include particular formations and graphics to convey specific whimsical features or other information about the goods contained therein.

While the present disclosure shows and demonstrates various example containers 10, 210 and 310 that are adapted for use in point of purchase displays of goods or in other display and dispensing formats, these examples are merely illustrative and are not to be considered limiting. It will be apparent to those of ordinary skill in the art that various containers and structures by which such containers may be supported can be constructed without departing from the scope or spirit of the present disclosure. Thus, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A container for holding and dispensing a plurality of items comprising:
a sidewall having an aperture therein;
a bottom connected to and closing the sidewall at a lower end of the sidewall; and
an inner wall connected to the sidewall and forming an interior flow control guide to force the items through a rearward restricted passage as the items move within the container downward toward the bottom and forward toward the aperture in the sidewall, wherein a plurality of items are simultaneously accessible through the aperture.

2. A container as defined in claim 1, wherein the sidewall and the inner wall are integrally formed within one panel.

3. A container as defined in claim 2, wherein the inner wall is bent along at least one fold line to form the interior flow control guide.

4. A container as defined in claim 3, wherein the inner wall further comprises tabs for additional connection to the sidewall.

5. A container as defined in claim 1, wherein the sidewall and the bottom are integrally formed within one panel.

6. A container as defined in claim 1, wherein the bottom is has an angled surface that provides a second flow control guide to tend to force the items forward within the container toward the aperture.

7. A container as defined in claim 1, wherein the bottom has a cylindrical sidewall and a rim extending in a plane outward from the sidewall.

8. A container as defined in claim 7, wherein the rim has an upward extending outer portion spaced from the cylindrical sidewall of the bottom.

9. A container as defined in claim 1, wherein sidewall includes teeth portions positioned adjacent the aperture in the sidewall.

10. A container as defined in claim 9, wherein the teeth portions are separately formed from the sidewall and connected to the sidewall along an inner surface of the sidewall.

11. A container as defined in claim 9, wherein the teeth portions are integrally formed with the sidewall.

12. A container as defined in claim 1, further comprising a lid that closes an upper end of the sidewall.

13. A container as defined in claim 12, wherein lid is configured to have a portion fit within the sidewall.

14. A container as defined in claim 12, wherein the lid is configured to engage the outer surface of the sidewall.

15. A container as defined in claim 1, wherein the container is configured to look like it has a mouth and teeth along upper and lower edges of the mouth.

16. A method of forming a container for holding and dispensing a plurality of items comprising:
forming a sidewall having an aperture therein;
connecting to the sidewall an inner wall in a form of an interior flow control guide to force the items through a rearward restricted passage as the items move downward within the container; and
closing a lower end of the sidewall with a bottom.

17. A method as defined in claim 16, wherein forming a sidewall further comprises bending a panel in the form of a cylinder.

18. A method as defined in claim 16, wherein forming a sidewall further comprises bending a panel at fold lines in the form of a rectangular tube.

19. A method as defined in claim 16, wherein forming a sidewall having an aperture therein further comprises forming teeth portions along upper and lower edges of the aperture.

20. A method as defined in claim 16, further comprising closing an upper end of the sidewall with a lid.
